(19) United States
(12) Patent Application Publication
(10) Pub. No.: US 2007/0022875 A1
(43) Pub. Date: Feb. 1, 2007

(54) Divided-typed piston structure having groove for assembling a rider ring in air compressor

(75) Inventor: Yong-hak Kim, Incheon (KR)

Correspondence Address: CANTOR COLBURN, LLP, 55 GRIFFIN ROAD SOUTH, BLOOMFIELD, CT, 06002, US

(73) Assignee: KOREA WESTERN POWER CO., LTD., Seoul (KR)

(21) Appl. No.: 10/567,812

(22) PCT Filed: Aug. 10, 2004
(86) PCT No.: PCT/KR04/02000

§ 371 Date: Feb. 9, 2006

(30) Foreign Application Priority Data
Aug. 13, 2003 (KR) 20-2003-0026124

(51) Int. Cl. F16J 1/00

(52) U.S. Cl. 92/172

(57) ABSTRACT

A divided-type piston of an air compressor, in which a piston rod shaft is inserted into a center portion thereof and reciprocally moves within a cylinder, has a piston body. The piston body is divided into an upper piston, an intermediate piston and a lower piston, and these pistons are integrally fixed and assembled by using a positioning pin, provided that the upper piston and the lower piston are formed with rider ring assembling grooves, and the intermediate piston is formed with compression ring assembling grooves. The rider rings are easily assembled to and disassembled from the piston, the time for assembling and disassembling the rider rings is shortened, and the components of the piston can be prevented from damage when the rides rings are assembled and disassembled.

### TECHNICAL FIELD

The present invention relates to a piston installed in an air compressor, and more particularly to a divided-type piston of an air compressor having a structure in which a rider ring is simply assembled around and disassembled from the outer circumference thereof so that time for disassembling the rider ring from the outer circumference is shortened and the rider ring and the piston are prevented from being damaged.

### BACKGROUND ART

As widely known in the art, an air compressor is a mechanical device for compressing air so as to increase pressure of the air, and a reciprocating piston type compressor is widely used as a typical example of the air compressor. A cylindrical piston installed in the conventional reciprocating piston type compressor repeats reciprocal movement within a cylinder so as to compress the air.

The conventional piston 102 in which a piston rod shaft is inserted into a center shaft hole 101 as shown in FIG. 3 is integrated with piston compression ring assembling grooves 105, formed on the outer circumference thereof between rider ring assembling grooves 104, for guiding the reciprocating piston 102. The integrated Teflon rider rings are assembled in the rider ring assembling grooves 104.

However, since, in order to assemble the rider rings in the rider ring assembling grooves 104, the rider rings must be heated and beaten to the positions of the rider ring assembling grooves 104 of the piston 102, the following problems are raised:

First, a lot time is required to heat the rider ring;

Since the rider ring must be heated and not directly touched by flame of a torch when expanding the rider ring, it takes approximately 2 hours to assemble one rider ring on the piston.

Second, damage and deformation of the rider ring due to the heat;

Since the heating of the rider ring is performed by hand, there is the difference of elongation between the heated portion and unheated portion of the rider ring, due to the local heating of the rider ring. Since the heated rider ring must be beaten into the rider ring assembling grooves by hammer, the rider ring may be damaged. Moreover, since the rider ring is made of resin, the property of the rider ring may be changed when it is heated to around 180° C.

Third, the damage of the piston when disassembling the rider ring;

Since the rider rings are assembled deeply within the rider ring assembling grooves, and the rider rings are cut into two or more pieces and disassembled from the divided-type piston by a sharp tool such as a knife, the aluminum piston may be damaged.

### DISCLOSURE

[Technical Problem]

Therefore, the present invention has been made in view of the above problems, and it is an object of the present invention to provide a divided-type piston in which a rider ring is easily assembled to and disassembled from a piston so that time to assemble and disassemble the rider ring is shortened and components of the divided-type piston are prevented from damage.

[Technical Solution]

In accordance with an aspect of the present invention, the above and other objects can be accomplished by the provision of a divided-type piston of an air compressor, in which a piston rod shaft is inserted into a center portion thereof and repeats reciprocal movement within a cylinder, the piston including a piston body divided into an upper piston, an intermediate piston, and a lower piston, the upper piston and the lower piston being respectively formed with rider ring assembling grooves, and the intermediate piston being formed with compression ring assembling grooves, and positioning pins for integrally fixing and assembling the upper piston, the intermediate piston, and the lower piston with each other.

[Advantageous Effects]

According to the divided-type piston of an air compressor of the present invention, the rider rings are easily assembled and disassembled, the time for assembly and disassembly of the rider rings can be shortened, and the rider rings and the piston can be prevented from damage when assembling and disassembling the rider rings.

### DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view showing a structure of divided-type piston according to the present invention;

FIG. 2 is a cross-sectional view of the assembled divided-type piston shown in FIG. 1; and

FIG. 3 is a cross-sectional view of an assembled conventional piston.

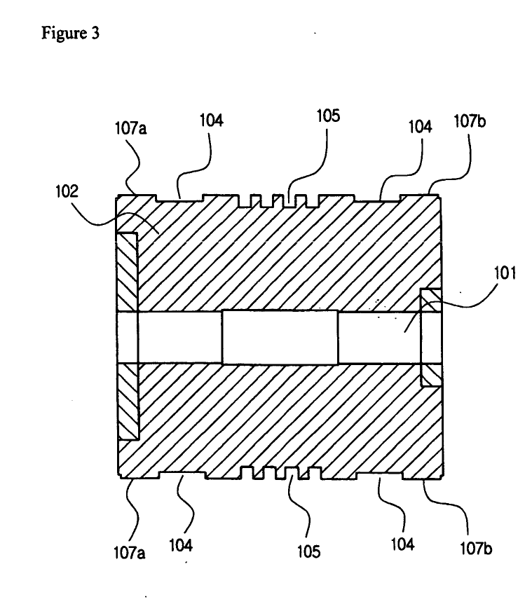

### BEST MODE

### MODE FOR INVENTION

Hereinafter, a divided-type piston according to the present invention will be described in detail by reference to the accompanying drawings.

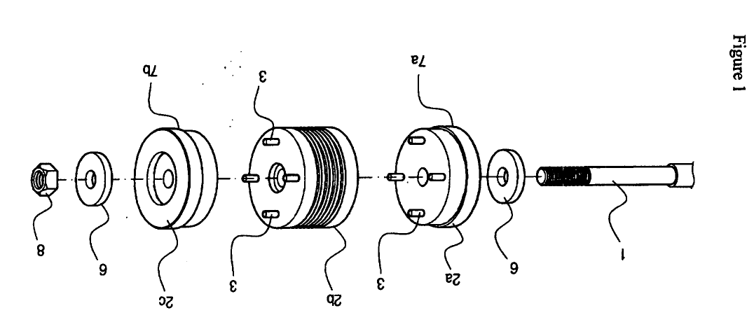

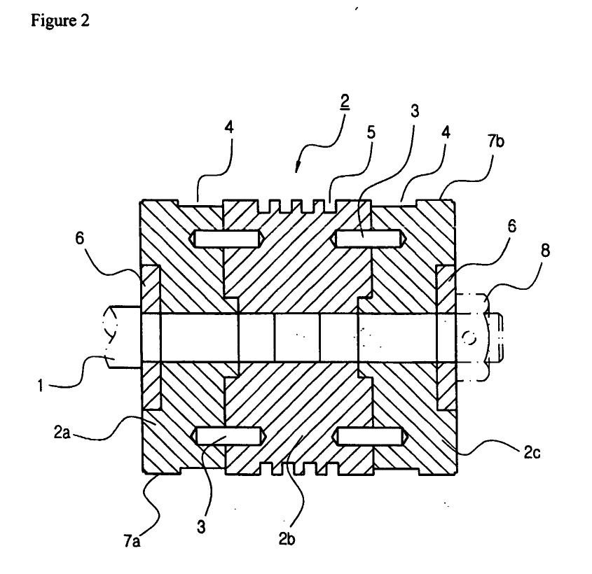

FIGS. 1 and 2 are an exploded perspective view showing a structure of divided-type piston and a cross-sectional view of the assembled divided-type piston according to the present invention, respectively.

A piston rod shaft 1 is inserted into a center portion of a piston of an air compressor that reciprocally moves within a cylinder. A piston body 2 is divided into an upper piston 2a, an intermediate piston 2b, and a lower piston 2c, and these pistons are integrally fixed and assembled by using a positioning pin 3, provided that the upper and lower pistons 2a and 2c are respectively formed with rider ring assembling grooves 4, and the intermediate piston 2b is formed with compression ring assembling grooves 5.

Reference numeral 6 represents a washer, reference numerals 7a and 7b represent an upper step and a lower step respectively, and reference numeral 8 represents a nut.

The rider rings are inserted into the rider ring assembling grooves 4 by using the positioning pin 3, and the three-divided pistons, i.e., the upper, intermediate, and lower pistons 2a, 2b, and 2c are then assembled. The nut 8 is fastened on the end of the piston rod shaft 1, and thus the piston is simply assembled. On the contrary, the nut 8 is released from the end of the piston rod shaft 1, and the positioning pin 3 is separated from the piston, so that the rider rings can be easily disassembled from the piston.

### INDUSTRIAL APPLICABILITY

As described above, according to the divided-type piston of the present invention, the rider rings are easily assembled to and disassembled from the piston, the time for assembly and disassembly of the rider rings is shortened, and the rider rings and the piston can be prevented from damage when assembling and disassembling the rider rings.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A divided-type piston of an air compressor, in which a piston rod shaft is inserted into a center portion thereof and reciprocally moves within a cylinder, characterized in that a piston body is divided into an upper piston, an intermediate piston and a lower piston, and these pistons are integrally fixed and assembled by using a positioning pin, provided that the upper piston and the lower piston are formed with rider ring assembling grooves, and the intermediate piston is formed with compression ring assembling grooves.
